(19) United States
(12) Patent Application Publication
(10) Pub. No.: US 2026/0209407 A1
(43) Pub. Date: Jul. 23, 2026

(54) PROCESS FOR THE PRODUCTION OF POLYETHYLENE

(71) Applicant: SABIC GLOBAL TECHNOLOGIES B.V., Bergen op Zoom (NL)

(72) Inventors: Yahya Banat, Riyadh (SA); Abdalaziz Mohammad A Almuneea, Riyadh (SA); Abdulrahman Yousuf Ashri, Riyadh (SA); Abderrahman Meddad, Riyadh (SA)

(21) Appl. No.: 19/140,125

(22) PCT Filed: Oct. 5, 2023
(86) PCT No.: PCT/EP2023/077565

§ 371 Date: Jun. 17, 2025

(30) Foreign Application Priority Data
Dec. 20, 2022 (EP) 22215210.0

(51) Int. Cl. C08F 210/02

(52) U.S. Cl. CPC C08F 210/02; C08F 2400/02

(57) ABSTRACT

A process for the production of polyethylene including the steps of (i) introducing ethylene, at least one polymerization catalyst, at least one activator, and an optional comonomer into a polymerization reactor, and (ii) polymerizing the ethylene. The polymerization catalyst is a supported chromium oxide based catalyst, and the activator is prepared separately prior to the introduction into the reactor and includes the reaction product of an alkyl aluminum compound and a nitrogen containing compound. The alkyl aluminum compound is an organo aluminum compound having the formula AlR₃, wherein R is selected from C₁-C₈ alkyl groups, and the nitrogen containing compound is a cycloalkylamine compound having the general formula R₂—NH₂. The ratio of Al:Cr is adjusted to primarily control the density of the polyethylene.

### CROSS REFERENCE TO RELATED APPLICATIONS

This application is a National Stage application of PCT/EP2023/077565, filed Oct. 5, 2023, which claims the benefit of European Application No. 22215210.0, filed Dec. 20, 2022, both of which are incorporated by reference in their entirety herein.

### FIELD OF THE INVENTION

The present invention relates to a process for the production of polyethylene in the presence of a supported chromium oxide based catalyst, in which process the density of polyethylene is controlled. The invention further relates to polyethylene obtained by the process and an article comprising the polyethylene.

### BACKGROUND OF THE INVENTION

The catalysts for the production processes of polyethylene can be divided in three different subclasses including Ziegler Natta catalysts, Phillips catalysts and single site catalysts. The molecular weight distribution is dictated largely by the catalyst employed. Polydispersities typically range from 2-3 for polyethylene made with single site catalyst, 4-6 for polymer produced with Ziegler-Natta catalyst and 8-20 for polyethylene made with Phillips catalyst.

The Phillips catalyst is a chromium oxide based, heterogeneous catalyst which can be obtained by calcining a chromium compound carried on an inorganic oxide carrier in a non-reducing atmosphere. The purpose of calcination of the chromium catalyst is dehydroxylation of the catalyst support and oxidation of any of the trivalent from of chromium (CrIII) to the hexavalent form (CrVI) and then stabilization of the hexavalent form. Phillips-type chromium catalysts are especially suitable for producing polyethylenes with a broad molecular weight distribution and a low level of long chain branching.

Organochromes like silylchromate derived catalysts are also extensively used for commercial PE manufacturing. The silylchromate catalyst consists of silylchromate (bis-triphenylsilyl chromate) absorbed on dehydrated silica and subsequently reduced with for example diethylaluminium ethoxide. The use of silyl chromate as a polymerization catalyst for olefin polymerization is disclosed in for example U.S. Pat. Nos. 3,324,095, 3,324,101 and 3,642,749. Silylchromate produced polyethylenes, under certain situations, have a higher number of benzene residues as compared to polyethylenes produced with chromium oxide based catalyst, which for certain health sensitive applications may limit their use due to regulatory restrictions.

The polymerisation of ethylene with supported chromium based catalysts is disclosed by Kevin Cann in “Comparison of silyl chromate and chromium oxide based olefin polymerisation catalysts” (Macromolecular Symp, 2004, 213, 29-36).

Chromium-based catalysts may be used in both slurry as well as gas phase polymerization processes. Gas-phase polymerization processes, such as fluidized bed polymerization, are particularly economical processes for the preparation of polyethylene. Gas-phase polymerization may be carried out in dry mode or condensed mode. Dry mode means that there is no condensation in the loop. Thus, no liquid is formed, and heat is removed from the gas stream without condensation. In condensed mode, a condensing agent is added to remove heat. For example, a condensing agent such as isopentane or isobutene is injected, after which it evaporates, which has a cooling effect and boasts productivity.

Using chromium-based catalysts in gas phase polymerizations operated in condensed mode for producing high density polyethylenes having a relatively high molecular weight has been challenging.

In both dry and condensed mode gas phase polymerization reactions, static generation is an area of concern. It is known that high levels of static are deleterious to continuous operation. Static can be generated by a variety of means, for example by conveying of dry catalyst into the reactor. In practice, dry catalyst feeders inject catalyst at a high velocity into the fluidizing bed through an injection tube. This high velocity injection of a dry powder, particularly an insulating powder such as a silica supported catalyst, can conceivably generate static. Anti-static agents such as amines or hydroxylated amines, which are well known antistatic agents, are often used to counteract the generation of static.

Activators may aid the catalyst performance. U.S. Pat. No. 6,989,344 B2 is directed to the use of aluminum alkyl activators to improve the performance of chromium-based catalysts. The aluminum alkyls act as scavenging agents for poisons to increase the catalyst activity. The aluminum alkyls allow for the variable control of polymer molecular weight, control of side branching while possessing desirable productivities, and may be applied to the catalyst directly or separately to the reactor.

WO 2006/130953 relates to polymerization processes with metallocene and Ziegler-Natta type catalysts. The application discloses that aluminum alkyls are often used as scavengers for olefin polymerization, but that an excess amount of scavenger will deactivate the catalyst. In addition to that antistatic agents such as amines or hydroxylated amines may deactivate chrome catalysts. According to WO 2006/13095, the mere addition of an antistatic agent (such as C18H37NH2) and a scavenger (such as aluminumalkyls) separately into the polymerisation reactor should be avoided. Thereto, an activator is prepared separately prior to being introduced into the polymerization reaction. The activator (cocatalyst aid) is a reaction product of an aluminum alkyl and an amine. Cycloalkylamines and chromium catalysis are not mentioned.

U.S. Pat. No. 8,703,887 B2 relates to polymerization of high density polyethylene in the presence of a supported chromium oxide based catalyst and an activator, wherein the activator comprises the reaction mixture of an alkyl aluminum compound and a nitrogen containing compound. The HDPE reactor powder obtained has Mw/Mn≥10 and ≤100 and a density ≥945 kg/m³ and ≤965 kg/m³. Cycloalkylamines are not mentioned. The experimental ratio of Al:Cr varies from 6.7-20. An influence of this ratio on the density is not disclosed.

WO 2020/152275 A1 relates to solid catalyst systems comprising a chromium compound, an aluminium alkoxide compound, a nitrogen containing compound and a silicon oxide support, wherein the nitrogen containing compound is a cycloalkylamine compound. The complete catalyst system is prepared before addition to the reactor, however the aluminum alkoxide compound and the nitrogen containing compound are not reacted before being mixed with the chromium compound and the silicon oxide support. Aluminum alkyl compounds are not mentioned.

WO 2022/214420 A1 relates to solid catalyst systems comprising a chromium compound, an aluminium alkoxide compound, a nitrogen containing compound and a silicon oxide support, wherein the nitrogen containing compound may be a cycloalkylamine compound. The reaction product of the aluminium alkoxide and the nitrogen containing compound is first separately prepared, after which the complete catalyst system is prepared before addition to the reactor. Aluminum alkyl compounds are not mentioned.

EP 3715385 A1 relates to a solid catalyst system comprising a first chromium compound, a second chromium compound, a reaction product of an alkyl aluminium compound and a nitrogen containing compound and a silicon oxide support. The first chromium compound is chromium trioxide or a compound convertible to chromium trioxide, the second chromium compound is a silylchromate compound. The nitrogen containing compound is a cycloalkylamine compound. The alkyl aluminium compound may be triisobutyl aluminium. The reaction product of the alkyl aluminium compound and the nitrogen containing compound is first separately prepared, after which the complete catalyst system is prepared before addition to the reactor.

WO 2016/206911 A1 relates to a process for the production of high density polyethylene by polymerization of ethylene in the presence of a silylchromate based catalyst and a reducing agent. The reducing agent comprises the reaction mixture of an alkyl aluminum compound and a nitrogen containing compound, wherein the alkyl aluminum compound is an organo aluminum compound having the formula AlR3, in which R is a hydrocarbon radical containing 1-10 carbon atom and wherein the nitrogen containing compound is a cycloalkylamine compound. The complete catalyst system is prepared before addition to the reactor. The reaction product of the alkyl aluminium compound and the nitrogen containing compound is not separately prepared before preparation of the catalyst system.

U.S. Pat. No. 6,921,798 B2 discloses polymerization processes for producing polyethylene having a target density and improved environmental stress resistance. Ethylene and optionally one or more α-olefin comonomers, supported chromium catalyst, and metal alkyl cocatalyst are contacted to produce polyethylene. The density of the polyethylene is determined, and the concentration of cocatalyst is adjusted in response to a deviation between the density of the polyethylene and the target density. The catalyst and cocatalyst can be fed separately into the reactor, or can be co-fed, eliminating the need to pre-contact the catalyst and cocatalyst prior to introducing them into the reactor.

Chromium oxide based catalysts have a high productivity (g PE/g catalyst) but a low space time yield operation. Furthermore, the range of produced polyethylene limits the final applications.

### SUMMARY

It is an objective of the present invention to overcome at least one of the abovementioned disadvantages, or least to provide a useful alternative. It especially is an objective of the present invention to provide a process for the production of polyethylene that results in a broader range of product properties such as density and melt flow index.

Thereto, the present invention provides a process for the production of polyethylene comprising the steps of
(i) introducing ethylene, at least one polymerization catalyst, at least one activator, and an optional comonomer into a polymerization reactor, and
(ii) polymerizing the ethylene,
wherein the polymerization catalyst is a supported chromium oxide based catalyst, and
wherein the activator is prepared separately prior to the introduction into the reactor and comprises the reaction product of an alkyl aluminum compound and a nitrogen containing compound,
wherein the alkyl aluminum compound is an organo aluminum compound having the formula AlR₃, wherein R is selected from C₁-C₈ alkyl groups, and
wherein the nitrogen containing compound is a cycloalkylamine compound having the general formula R₂—NH₂,
wherein the ratio of Al:Cr is adjusted to control the density of the polyethylene.

The ratio of Al:Cr is adjusted to primarily control the density of the polyethylene even at a constant temperature, ethylene partial pressure, comonomer/ethylene molar ratio, hydrogen/ethylene molar ratio, and oxygen concentration.

Thus, in step (i), ethylene, the at least one polymerization catalyst, at least one activator, and optional comonomer are separately introduced into the reactor. This as opposed to preparing a catalyst system from the catalyst and the activator and introducing the entire catalyst system into the reactor. The separate introduction of the catalyst and the activator allows to adjust the Al:Cr ratio during the process.

### DETAILED DESCRIPTION

Surprisingly, by adjustment of the Al:Cr ratio, the properties of the produced polyethylene are highly adjustable and the process has a high space time yield. The density of the polyethylene can be adjusted in the range of 0.910 to 0.960 g/cm³, with limited addition of alpha-olefin comonomer. Specifically surprisingly, the process is suitable for preparing polyethylene with a density less than 0.945 g/cm³, and even less than 0.940 or even 0.930 g/cm³. Thus, very low densities may be achieved. MFI may range from 1 to 50 g/10 min, such as from 2 to 45 g/10 min.

The invention thus provides a polymerization process for producing polyethylene having a target density. For example, the density of the produced polyethylene may be monitored and the ratio of the activator and the catalyst is adjusted in response to a deviation between the density of the polyethylene and a target density. If the density is monitored after the polymerization process, the adjustment of the ratio is implemented in a subsequent polymerization process. In the case where the density is monitored during the polymerization, the process especially provides for the opportunity of a quick response to any deviation in density in order to provide polyethylene with the desired properties. The Al:Cr ratio adjustment is most conveniently achieved by adjusting the concentration of the activator, as this reduces the influence of the adjustment on the overall reaction process. In practice, the Al:Cr ratio adjustment is especially conveniently achieved by adjusting the flow ratio of activator to the catalyst feed, which is kept constant at steady-state operation.

Optionally, after achieving the target density, the ratio of Al:Cr is kept constant, and the concentration of comonomer is adjusted to further control the density of the polyethylene. Specifically, the concentration of comonomer is adjusted in response to a further deviation between the density of the polyethylene and the target density.

Preferably, the molar ratio of comonomer to ethylene is less than 0.25, more preferably less than 0.1.

Preferably, the molar ratio of Al:Cr is between 0.0001:1 and 1:1, more preferably between 0.001:1 and 1:1, most preferably between 0.001:1 and 0.1:1. Preferably, the molar amount of Al is less than the molar amount of Cr.

Preferably, the molar ratio of Al:N is between 2.5:1 and 3.3:1, more preferably between 2.6:1 and 3.2:1, most preferably between 2.7:1 and 3.1:1.

Preferably, the molar ratio Cr:N is between 10 and 10000, more preferably between 100 and 1000.

### Supported Chromium Oxide Based Catalyst

The polymerization catalyst contains a support. Preferably the support is a silica support. A silica support that is suitable for use in the present invention has a relatively high surface area and is amorphous. The silica may have a surface area (SA) larger than 150 m²/g and a pore volume (PV) larger than 0.8 cm³/g. The support may be modified so as to include cogels such as for example silica-titania or silica-alumina and by the replacement of silica by alumina or amorphous aluminum phosphates. Furthermore, the support may comprise a tergel which is produced by mixing a chromium source with the silica and titania compound. The chromium containing catalyst may also be doped with chemical compounds containing for example aluminum, titanium, phosphorus, boron or fluor for example by impregnation of the porous chromium containing supports with a solution of any one of these compounds.

One skilled in the art recognizes that a supported chromium oxide based catalyst differs from a silyl chromate catalyst. Thus, the supported chromium oxide based catalyst is not a silyl chromate catalyst. Preferably, the polymerization catalyst is free of silyl chromate based catalyst.

Preferably, the catalyst is an unmodified silica supported chromium based catalyst having a pore volume larger than 0.8 cm³/g and a specific surface area of at least 150 m²/g.

The properties of the catalyst, pore volume and specific surface area are determined before the catalyst is activated at an elevated temperature.

The amount of chromium in the catalyst is generally between 0.01 and 10 wt. %, preferably from 0.1-3 wt. % by weight of chromium, calculated as metallic chromium, based on the weight of the catalyst. Preferably the amount of chromium in the catalyst is at least 0.3% by weight.

The average particle size (D₅₀) of the catalyst may range between for example 15 and 150 micrometers. Generally, the catalyst is activated before being applied in the polymerization reaction. The activation may take place under different conditions. The activation generally takes place at an elevated temperature, for example, at a temperature above 450° C. The activation may take place in different atmospheres, for example in dry air. Generally, the activation takes place at least partially under an inert atmosphere preferably consisting of nitrogen. At the same time the temperature is raised slowly. It has been found to be advantageous to change from the nitrogen atmosphere to an atmosphere of dry air at a temperature of at most 700° C. The activation time after reaching the maximum temperature may last for several minutes to several hours. This activation time is at least 1 hour but it may be advantageous to activate much longer.

Preferably, the catalyst system further comprises a non-chromium metal compound, i.e. a metal compound which contains a metal which is not chromium. This non-chromium metal compound acts as a modifier and is used for the synthesis of the solid catalyst component according to the invention.

Preferably, the non-chromium metal compound is a metal halide transition metal compound and is selected from compounds represented by formulas Tm(OR⁴)ₙX₄₋ₙ and Tm(R⁵)ₙX₄₋ₙ, wherein Tm represents a transition metal of Group IVB, VB, or VIB, R⁴ and R⁵ are independently selected from C1-C20 alkyl groups, C1-C20 aryl groups and C1-C20 cycloalkyl groups, X represents a halogen atom, preferably chlorine and n represents a number satisfying 0≤n≤4, preferably 1≤n≤4.

Preferably, the metal in the non-chromium metal compound, Tm, is selected from titanium, vanadium, hafnium and zirconium, and is most preferably titanium.

Examples of suitable titanium compounds include titanium alkoxy compounds for example tetraethoxy titanium, tetramethoxy titanium, tetrabutoxy titanium, tetrapropoxy titanium (in particular tetraisopropoxy titanium), tetraisobutoxy titanium, tetrapentoxy titanium, triethoxychloro titanium, diethoxydichloro titanium, trichloethoxy titanium, methoxy titanium trichloride, dimethoxy titanium dichloride, ethoxy titanium trichloride, diethoxy titanium dichloride, propoxy titanium trichloride, dipropoxy titanium dichloride, butoxy titanium trichloride, butoxy titanium dichloride and titanium tetrachloride.

Other suitable non-chromium metal compounds include for example vanadium trichloride, vanadium tetrachloride, vanadium oxytrichloride and zirconium tetrachloride.

Preferably, the amount of the metal in the non-chromium metal compound in the solid catalyst system, in particular the amount of Ti in the solid catalyst system, is between 0.1 and 10.0 wt. %, preferably in the range between 0.1 and 6.0 wt. %.

Preferably, the weight ratio between the metal in the non-chromium metal compound in the solid catalyst system and Cr, in particular Ti:Cr, is in the range of 2:1-4:1.

Preferably, the catalyst is a silica supported chromium oxide based catalyst with 0.5 wt % of chromium. More preferably, the catalyst has a surface area of 300 m²/g and a pore volume of 1.5 cm³/g.

Preferably, the productivity of the catalyst is between 10-14 kg/g.

### Activator

The activator, which comprises the reaction product of an alkyl aluminum compound and a nitrogen containing compound, is prepared separately prior to the introduction into the reactor. This means that the reaction must have taken place before the alkyl aluminum compound and the nitrogen containing compound come into contact with the other elements of the solid catalyst system. This avoids problems with static as well as deactivation of the catalyst. Furthermore, this allows controlling the reaction process of the alkyl aluminum compound and the nitrogen containing compound without the presence of other components such as the polymerization catalyst, making it easier to provide the desired reaction product. The reaction process of the alkyl aluminum compound and the nitrogen containing compound can be optimized in the absence of other components. Thus, easy and simplified scaling-up can be achieved.

### Alkyl Aluminum Compound

The alkyl aluminum compound is an organo aluminum compound having the formula AlR₃, wherein R is selected from C₁-C₈ alkyl groups. Suitable examples of organo aluminum compound of the formula AlR₃ include for example trimethyl aluminium, triethyl aluminium, triisobutyl aluminium, tri-n-hexyl aluminium and tri octyl aluminium. Preferably trimethyl aluminium, triethyl aluminium or triisobutyl aluminium is applied, most preferably triisobutylaluminum.

### Nitrogen Containing Compound

The nitrogen containing compound is a cycloalkylamine compound having the general formula R₂—NH₂, wherein R₂ represents a cycoalkyl having from 5-20 carbon atoms. The nitrogen containing compound includes substituted derivatives thereof, for example derivatives substituted with one or more alkyl groups, such as methyl and/or ethyl.

Preferably the nitrogen containing compound is an optionally substituted cyclohexylamine. The preparation of the activator with such a nitrogen containing compound is especially uncomplicated. Most preferably, the nitrogen containing compound is cyclohexylamine.

### Comonomer

Typical comonomers in the production of an ethylene copolymer may be propylene, 1-butene, 1-pentene, 4-methyl-1-pentene, 1-hexene and/or 1-octene. Most preferably, the comonomer is 1-hexene. Without wishing to be bound by theory, it is believed that process of the invention results in the in situ formation of polymerizable comonomer, which has a higher probability of being incorporated into the polyethylene. In this description and the claims, unless specifically mentioned otherwise, the term comonomer is meant to define the comonomer that has been introduced into the polymerization reactor, rather than such in situ formed comonomer.

### Reactor

The polymerization takes place in a single reactor and may be performed via a gas phase process or via a slurry process. Preferably, the polymerization of the invention is conducted in the gas phase.

In general, a fluidized bed gas phase polymerization reactor employs a “bed” of polymer and catalyst which is fluidized by a flow of monomer, comonomer and other optional components which are at least partially gaseous. Heat is generated by the enthalpy of polymerization of the monomers flowing through the bed. Unreacted monomers and other optional gaseous components exit the fluidized bed and are contacted with a cooling system to remove this heat. The cooled gas stream, including monomer, comonomer and optional for example condensable liquids, is then re-circulated through the polymerization zone. Simultaneously, polymer product is withdrawn from the reactor. The reactor temperature in a gas phase process may range between for example 30° C. and 130° C. A description of a gas phase process is disclosed in for example U.S. Pat. Nos. 4,543,399 and 4,588,790.

Suitable fluidized bed reactors include for example a bubbling fluidized bed reactor, a circulating fluidized bed reactor, an annular fluidized bed reactor, a multi-zone fluidized bed reactor and a flash reactor. With ‘fluidized bed’ is meant that an amount of solid particles (in this case preferably the solid catalyst and/or the solid catalyst to which the monomer is attached) in a solid/fluid mixture acts as a fluid. This can be achieved by placing the amount of solid particles under appropriate conditions, for instance by the introduction of fluid through the solid particles at a high enough velocity to suspend the solid particles and causing them to behave as a fluid. An example of a process using a fluidized bed for producing polyolefins is disclosed in U.S. Pat. No. 4,882,400. Other examples of processes using a fluidized bed for producing polyolefins are described in, for example, U.S. Pat. Nos. 3,709,853; 4,003,712; 4,011,382; 4,302,566; 4,543,399; 4,882,400; 5,352,749; 5,541,270; 7,122,607, and 7,300,987.

The reaction temperature may be used to further control the density of the produced polyethylene. Preferably, the reaction temperature is between 8° and 110° C., such as between 85 and 105° C. In this case, polyethylene with a density between 0.915 and 0.955 g/cm³ may be produced.

In slurry reactors, a low boiling hydrocarbon solvent such as isobutane, hexane or heptane is employed as a continuous medium, and monomer, catalyst, etc. are added to this continuous phase. The polymer formed is insoluble in the reaction medium, producing slurry of polymer and catalyst. Slurry reactors may be divided into loop reactors and boiling solvent reactors. Heat is at least partially removed by the heat of vaporization of solvent, which is later condensed and returned to the reactor. Polymer is removed as slurry from the bottom of the reactor and flashed to remove solvent, which is recycled. Slurry loop reactors may be horizontally or vertically oriented. Water flowing between the tubes serves to remove heat and maintain a relatively constant temperature. Slurry flow is achieved by pumps which maintain the polymer slurry at relatively high velocity. Product is removed either continuously or discontinuously from a “settling leg.” Preferably, the polymerization of ethylene takes place in a diluent at a temperature of between 80° C. and 110° C. Suitable diluents include, for example, isobutane and propane.

### Polyethylene

The invention further provides for polyethylene obtained by or obtainable by the process according to the invention, as well as articles comprising the polyethylene. The ethylene polymers obtained with the process according to the invention may be combined with additives such as for example lubricants, fillers, stabilizers, antioxidants, compatibilizers and pigments. The additives used to stabilize the copolymers may be, for example, additive packages including hindered phenols, phosphites, UV stabilsers, antistatics and stearates.

The ethylene polymers may be extruded or blow-moulded into articles such as for example bottles, containers, fuel tanks and drums, and may be extruded or blown into films.

The polyethylene obtained with the process according to the present invention has tunable properties in the range of:
MFI from 1 to 50 g/10 min (according to ASTM D-1238 @190° C., 21.6 kg)
a density ≥910 kg/m³ and s 960 kg/m³ (according to D-1505).

### Examples

### Catalyst A

A silica supported chromium oxide based catalyst with 0.5 wt % of chromium, 1.8 wt % of titanium, a surface area of 300 m²/g and a pore volume of 1.5 cm³/g was activated in an atmosphere of dry air at a temperature of 825° C. for 3 hours using a tube furnace.

### Activator I

To a round bottom flask, fitted with a stirrer and placed in an oil bath, 248.1 ml of neat triisobutyl aluminum was added, followed by the addition of 633.1 ml of isopentane, followed by the addition of 37.6 ml of ml of cylohexylamine, and allowed to mix at a temperature of 65° C. for 30 minutes. The reaction gave off isobutane gas in the form of bubbles. Triisobutyl aluminum cyclohexylamine was obtained. Then, isopentane was added to achieve a final concentration of 0.0005 wt % of triisobutyl aluminum cyclohexylamine.

### Fluidized Bed Polymerization

Catalyst A was tested in a continuous gas phase fluidized bed reactor having an internal diameter of 45 cm and a reaction zone height of 140 cm. The bed of polymer particles in the reaction zone was kept in a fluidized state by a recycle stream that worked as a fluidizing medium as well as as a heat dissipating agent for absorbing the exothermal heat generated within reaction zone. The reactor was kept at a constant temperature and at a constant pressure of about 21.7 bar. Ethylene and hexene, oxygen and hydrogen were used as the raw materials for polymerization. These materials form a make-up stream. Activator I was mixed with the make-up stream as a 2% by weight solution in isopentane carrier solvent.

The solid catalyst was injected directly in the reaction zone of the fluidized bed using purified nitrogen as a carrier gas and was thus introduced separately from the activator. Changing the feeding ratio of the catalyst and activator allowed adjustment of the Al/Cr ratio. The injection rate of the catalyst was adjusted to maintain a constant production rate of about 12 kg/hr. The produced polymer was discharged from the reaction zone semi-continuously via a series of valves into a fixed volume chamber.

The so obtained product was purged to remove any volatile hydrocarbons and was then treated with humidified nitrogen to deactivate any trace quantities of residual catalyst composition.

TABLE 1

| | | | | | | | Al/Cr | MFI | Density | |
|---|---|---|---|---|---|---|---|---|---|---|
| | T | C2 | H2/C2 | C6/C2 | C4 | Act. I/C2 | (mol/k | (g/10 | 0.001 ± | Ash |
| Ex. | (° C.) | (bara) | (v/v) | (v/v) | (mol %) | (ppb) | mol) | min) | (g/cm³) | (ppm) |
| 1 | 100 | 15 | 0.016 | 0.001 | 0.08 | 2 | 1.3 | 10 | 0.952 | <100 |
| 2 | 100 | 15 | 0.015 | 0.002 | 0.12 | 4 | 1.7 | 4 | 0.950 | <100 |
| 3 | 100 | 15 | 0.011 | 0.004 | 0.25 | 12 | 3.4 | 3 | 0.948 | <100 |
| 4 | 100 | 15 | 0.018 | 0.015 | 1 | 18 | 8.3 | 10 | 0.940 | <100 |
| 5 | 100 | 15 | 0.013 | 0.017 | 1.1 | 63 | 27.3 | 35 | 0.935 | <100 |
| 6 | 89 | 15 | 0.015 | 0.044 | 3.2 | 5 | 2.6 | 26 | 0.922 | <100 |
| 7 | 89 | 15 | 0.016 | 0.044 | 2.9 | 6 | 3.9 | 26 | 0.920 | <100 |
| 8 | 87.5 | 15 | 0.013 | 0.044 | 3.24 | 7 | 4.2 | 40 | 0.918 | <100 |
| Comp. | 107 | 15 | 0.2 | 0.002 | 0 | 0 | 0 | 35 | 0.954 | <100 |
| Example | | | | | | | | | | |

C2 = ethylene monomer partial pressure
H2/C2 = volume ratio of hydrogen to ethylene monomer
C6/C2 = volume ratio of hexene comonomer to ethylene monomer
C4 = 1-butene in reactor as measured by online GC
Act. I/C2 = ratio of Activator I to ethylene monomer
Al/Cr = ratio of aluminum to Cr
MFI = Melt flow index as measured by ASTM D-1238 (190° C., 21.6 kg)
Density = Density as measured by ASTM D-1505
Ash = Ash content as measured by ASTM D-1921

The results of examples 1-5 show that adjusting the Al:Cr ratio at constant temperature, constant ethylene partial pressure, constant comonomer:ethylene ratio, constant hydrogen:ethylene ratio and/or constant oxygen concentration can be used to tune the MFI and density of the products. A higher Al:Cr ratio results in a lower density, while in all cases the amount of external comonomer needed to obtain low density PE is significantly lower than in prior art synthesis methods.

The results of examples 6-8 indicate that increasing the C6/C2 ratio at lower polymerization temperatures results in products with a lower density range.

1. A process for the production of polyethylene comprising the steps of
(i) introducing ethylene, at least one polymerization catalyst, at least one activator, and an optional comonomer into a polymerization reactor, and
(ii) polymerizing the ethylene,
wherein the polymerization catalyst is a supported chromium oxide based catalyst, and
wherein the activator is prepared separately prior to the introduction into the reactor and comprises the reaction product of an alkyl aluminum compound and a nitrogen containing compound,
wherein the alkyl aluminum compound is an organo aluminum compound having the formula AlR₃, wherein R is selected from C₁-C₈ alkyl groups, and
wherein the nitrogen containing compound is a cycloalkylamine compound having the general formula R₂—NH₂, wherein R₂ represents a cycoalkyl having from 5-20 carbon atoms,
wherein the ratio of Al:Cr is adjusted to control the density of the polyethylene.

2. The process according to claim 1, wherein the ratio of Al:Cr is adjusted at constant temperature, constant ethylene partial pressure, constant comonomer/ethylene molar ratio, constant hydrogen/ethylene molar ratio and/or constant oxygen concentration.

3. The process according to claim 1, wherein the ratio of Al:Cr is adjusted by adjusting the concentration of the activator and/or by adjusting a flow ratio of activator to catalyst feed.

4. The process according to claim 1, wherein after achieving a target density, the ratio of Al:Cr is kept constant, and the concentration of comonomer is adjusted to further control the density of the polyethylene.

5. The process according to claim 1, wherein the molar ratio of Al:Cr is between 0.0001:1 and 1:1.

6. The process according to claim 1, wherein the molar ratio of Al:N is between 2.5:1 and 3.3:1.

7. The process according to claim 1, wherein the molar ratio of comonomer:ethylene is less than 0.25:1.

8. The process according to claim 1, wherein the cycloalkyl amine compound is optionally substituted cyclohexylamine.

9. The process according to claim 1, wherein the organo aluminum compound is chosen from the groups consisting of trimethyl aluminum, triethyl aluminum, triisobutyl aluminum, tr-n-hexyl aluminum, trioctylaluminum, and combinations thereof.

10. The process according to claim 1, wherein the polymerization catalyst further comprises a non-chromium metal compound.

11. The process according to claim 10, wherein the weight ratio of Ti:Cr is between 2:1 to 4:1.

12. The process according to claim 1, wherein the density of polyethylene as measured by ASTM D-1505 is between 0.910 and 0.960 g/cm³.

13. The process according to claim 1, wherein the polymerization is conducted in the gas phase.

14. A polyethlene obtained by the process according to claim 1.

15. An article comprising the polyethylene according to claim 14.
